(19) United States
(12) Patent Application Publication
(10) Pub. No.: US 2010/0267427 A1
(43) Pub. Date: Oct. 21, 2010

(54) ELECTRONIC DEVICE WITH MOVABLE HOUSING PARTS

(75) Inventors: Martin Wraber, Copenhagen (DK); Joakim Korner Nielsen, Aalborg (DK); Christine Broe, Aalborg (DK)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/439,532

(22) PCT Filed: Aug. 29, 2006
(86) PCT No.: PCT/EP2006/008437

§ 371 Date: May 18, 2010

(51) Int. Cl. H04W 88/02

(52) U.S. Cl. 455/575.4

(57) ABSTRACT

A mobile electronic device comprises a housing with a first housing part, a second housing part and a third housing part that are mounted for a slidable movement relative to one another between a compact housing position, an intermediate housing position and an elongated housing position. In the compact position a large part of the operating face of the device is concealed. In the intermediate position an area of the operating face is concealed whilst another area of the operating face is not concealed. In the elongated position the operating face is not concealed. In the compact position the electronics of the device may assume a dormant state. When the housing parts are moved out of the compact position the electronics assume an active state.

### FIELD OF THE INVENTION

The present invention relates to mobile electronic devices that include a housing having at least three housing parts that are movable relative to one another, in particular to mobile electronic devices that have at least three housing parts that are movable relative to one another to conceal and unconceal an operating face.

### BACKGROUND OF THE INVENTION

Mobile electronic devices with two housing parts that can be moved between a retracted position in which a keypad is concealed and an extended position in which the keypad is not concealed are known in the art.

Due to the ever-increasing functionality of mobile electronic devices and the increasing integration into the every day life of the users there is a desire for an improved user control over these mobile electronic devices.

### DISCLOSURE OF THE INVENTION

On this background, it is an object of the present invention to provide a mobile electronic device that at least partially fulfills the above desire. This object is achieved by providing a mobile electronic device comprising a housing having at least a first housing part, a second housing part, and a third housing part, the third housing part being mounted for slidable movement relative to the second housing part between an extended position and a retracted position, the second housing part being mounted for slidable movement relative to the first housing part between an extended position and a retracted position, the housing being configured to be able to assume a compact position in which the third housing part is in its retracted position relative to the second housing part and in which the second housing part is in its retracted position relative to the first housing part, the housing being configured to be able to assume an intermediate position in which the third housing part is in its retracted position relative to the second housing part and in which the second housing part is in its extended position relative to the first housing part, and the housing being configured to be able to assume an elongated position in which the third housing part is in its extended position relative to the second housing part and in which the second housing part is in its extended position relative to the first housing part.

The three position construction provides for increased flexibility of the physical state of the electronic device. A particular state of the electronics inside the housing can be associated with each of these physical states. Different parts of the user interface can be concealed or unconcealed in the respective physical states. Thus, the flexibility of use in the control over access to and activity of the electronic device is improved.

Preferably, the direction of the slidable movement between the third housing part and the second housing part is substantially identical with the slidable movement between the second housing part and the first housing part.

The electronic device may further include an operating face that includes at least two distinct operating face areas, wherein the first housing part conceals both of the two distinct operating face areas in the compact position, the first housing part conceals only one of the two distinct operating face areas in the intermediate position, and the first housing part does not conceal any one of the two distinct operating face areas in the elongated position.

Thus, in a compact state neither of the two operating face parts can be accessed (other parts of the operating face may still be accessible), in the intermediate state a portion of the operating face can be used, whilst in the elongated state the complete operating face can be used. The plurality levels of access to the operating face allow for more differentiated mechanical level of access to the user interface, thereby improving the level of control over the device available to the user.

Preferably, the electronic system of the device assumes a dormant state when the housing parts are brought into the compact position. Thus, the retracted position can be used to ensure that battery consumption is minimized and that the device will not initiate any activities that may be disturbing in particular environments in which the user stays.

The electronic system may assume an active state when the housing is moved out of the compact position.

Preferably, the compact position, the intermediate position and the elongated position are stable positions. In this case, a given amount of force has to be applied to the housing parts before they move out of one of the stable positions.

The compact position may be an automatically locking position that requires pressing of one or more release keys to unlock.

One or more release keys may have to be pressed before the housing parts can be moved from the intermediate position to the compact position.

Preferably, the intermediate position is in between the retracted position and the extended portion.

A first of the distinct operating face areas may include an alphanumerical keypad. The alphanumeric keypad can be a UTI-T keypad.

A second of the distinct operating face areas may include navigational user interface components. The second distinct operating face area may also include one or more softkeys.

Further objects, features, advantages and properties of the mobile electronic device according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 is a front view of the mobile electronic device according to the present invention in a compact state,

FIG. 2 is a front view of the mobile electronic device of FIG. 1 in an intermediate state,

FIG. 3 is a front view of the mobile electronic device of FIG. 1 in an elongated state,

FIGS. 4 to 6 are elevational views of the mobile electronic device of FIG. 1 in the compact-, intermediate- and elongated positions, and

FIG. 7 is a block diagram illustrating the general architecture of a mobile electronic device in accordance with the present invention.

### DETAILED DESCRIPTION OF PREFERRED EMBODIMENTS

In the following detailed description, the mobile terminal electronic device according to the invention in the form of a cellular/mobile phone will be described by the preferred embodiments.

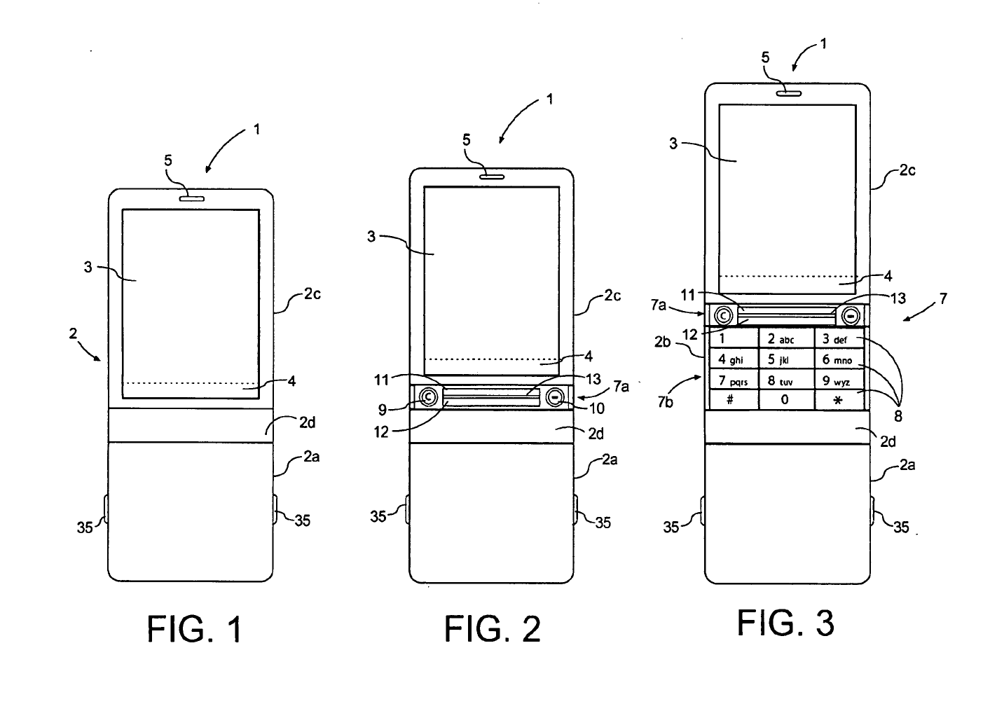

FIGS. 1 to 3 illustrate a first embodiment of a mobile terminal that is provided with a scroll bar according to the invention in the form of a mobile telephone 1 by a series of front views. In FIG. 1 the mobile phone is in a compact position, in FIG. 2, the mobile phone is in an intermediate position, and in FIG. 3 the mobile phone is in an elongated position. These three positions of the mobile phone will be explained in detail further below.

The mobile phone 1 comprises a user interface having a housing 2, a display 3, an on/off button (not shown), a speaker 5 (only the opening is shown), and a microphone 6 (not visible in FIG. 1). The housing 2 comprises a first housing part 2a, a second housing part 2b and a third housing part 2c. The phone 1 according to the present embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

The keypad 7 has in a first keypad area 7a a first group of keys comprising a clear key 9, a softkey 10, a scroll/navigating key 11 for scrolling/navigating up and a scroll/navigating key 12 for scrolling/navigating down and a scroll bar 13 for scrolling/navigating left and right. The scroll bar may include an array of capacitive touch sensors (not shown). The function of the softkey 10 is shown as a soft label in a dedicated area 4 for the display 3 just above the softkey 10 and depends on the state of the mobile phone 1, and navigation in the menu is performed by using the scroll keys 11,12 and the scroll bar 13.

The keypad 7 has a second group of keys 8 as alphanumeric keys in a second keypad area 7b. By means of the alphanumerical keys the user can enter a telephone number, write a text message (SMS), write a name (associated with the phone number), etc. Each of the twelve alphanumeric keys 8 is provided with a figure “0-9” or a sign “#” or “*”, respectively (corresponding to an UTI-T keypad). In alpha mode each key is associated with a number of letters and special signs used in the text editing.

The softkey 10 is used for selecting the function indicated in the area 4 whilst the clear key 9 is used for stepping back in the menu structure, clearing characters and call rejection. The functions indicated in the area 4 include call handling functions such as initiating a call, terminating a call and any other functions that can be performed by a mobile phone.

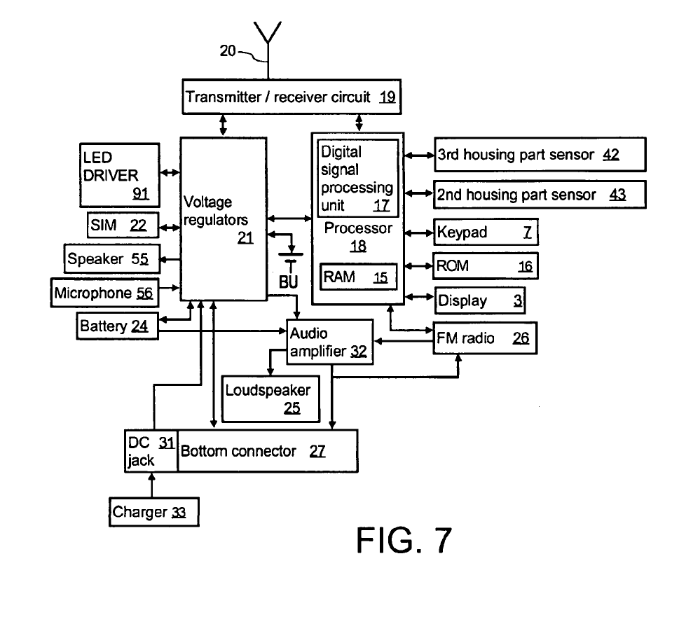

A releasable rear cover (not shown) gives access to the SIM card 20 (FIG. 7), and the battery pack 24 (FIG. 7) in the back of the phone that supplies electrical power for the electronic components of the mobile phone 1.

The mobile phone 1 has a flat display 3 that is typically made of an LCD with optional back lighting, such as a TFT matrix capable of displaying color images. A touch screen may be used on top of a conventional LCD display.

FIGS. 3 to 6 show a mobile phone according to a second embodiment of the invention series of elevated views. The mobile phone according to the second embodiment is essentially identical to the mobile phone of the first embodiment, the second embodiment differs only from the first embodiment by the aesthetic design aspects and the fact that the second embodiment further includes dedicated call handling keys in the form of an on-hook key 52 and an off-hook key 53.

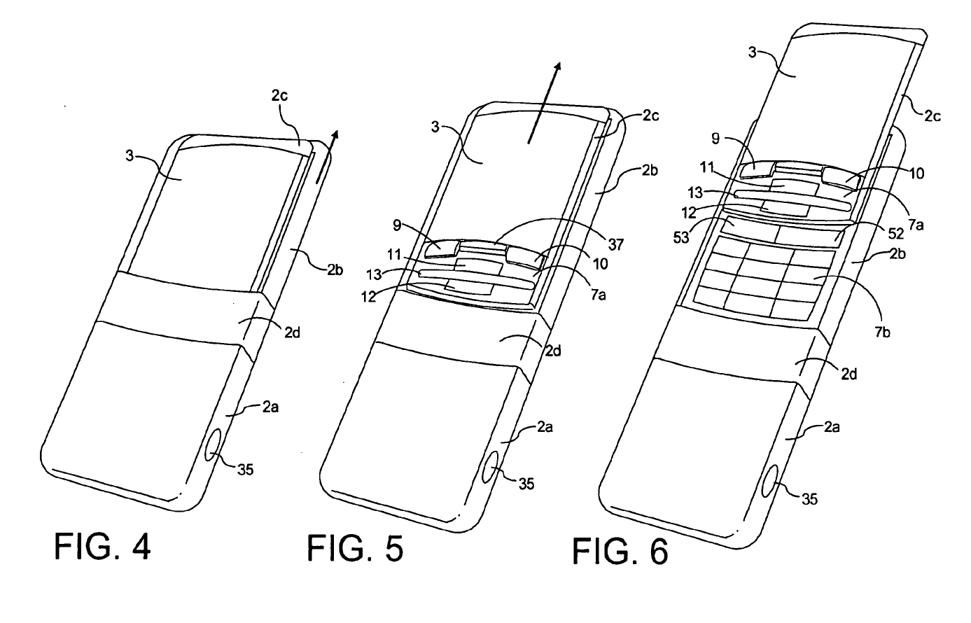

Housing part 2a includes an elastic portion 2d, for example made from natural or synthetic rubber. Housing part 2b is slidably received inside housing part 2a, and can move between a retracted position (cf. FIGS. 1 and 4) and an extended position (cf. FIGS. 2 and 5). The slidable suspension between housing part 2a and housing part 2b is suitably formed by rails and tracks (not shown). Resilient means (not shown) may be provided to urge the second housing part 2b towards the extended position.

A locking mechanism (not shown) automatically locks the second housing part 2b relative to the first housing part 2a and thereby prevents the second housing part 2b from moving to its extended position under the influence of the resilient means. The locking mechanism is released by simultaneously pressing the two release keys 35 on the opposite sides of the mobile phone 1. When the phone is in the compact position (FIGS. 1 and 4) and the user presses both release keys 35 simultaneously, the second housing part 2b moves (under influence of the resilient means) to its extended position and the mobile phone 1 assumes its intermediate position (FIGS. 2 and 5). The third housing part 2c moves in unison with the second housing part 2b. The first keypad area 7a is in the intermediate position not concealed by the first housing part 2a. Thus, the user has now access to the navigation keys 11,12,13, the soft key 10 and the clear key 9. In the compact position of the mobile phone 1, thy keypad area 7a was covered by the elastic portion 2d of the first housing part 2a.

In order to reassume the compact state, the user will need to push the second housing part 2b against the force of the resilient means to its retracted position, where the locking mechanism will automatically engage. According to an embodiment, the user will need to press the release keys 35 before it is possible to move the second housing part 2c from its extended position towards its retracted position.

The third housing part 2c is slidably suspended from the housing part 2b, and can move between a retracted position (cf. FIGS. 1,2,4 and 5) and an extended position (cf. FIGS. 3 and 6). The slidable suspension between housing part 2a and housing part 2b and between housing part 2b and housing part 2c is suitably formed by rails and tracks (not shown). A resilient bistable mechanism (not shown) may urge the third housing part 2c towards its extended position and towards its retracted position with a substantially neutral area in the middle between these the two extreme positions of the third housing part 2c. A ridge 37 allows the user to push the third housing part 2c to a desired position. In the elongated position (FIGS. 3 and 6) second keypad area 7b is no longer concealed by the third housing part 2c and therefore the user has in the elongated position access to the alphanumerical keys (and the dedicated call handling keys 52 and 53 in the second embodiment).

The sliding mechanisms in the mobile phone 1, are according to an embodiment of the invention configured to prevent the second housing part 2b from assuming its retracted position when the third housing part 2c is in its extended position. Thus, the third housing part 2c has to be in its retracted position before the second housing part 2b can assume its retracted position to place the mobile phone 1 in its compact state.

In the compact position of the mobile phone (FIGS. 1 and 4) only the area of the operating face occupied by the display is visible and accessible to the user. In the intermediate position of the mobile phone 1, only the area of the operating face occupied by the display and by the first keypad portion 7a with the navigation keys and soft/clear key are visible and accessible to the user. In the extended position of the mobile phone 1 the complete operating face is visible and accessible to the user.

The electronic components of the mobile phone 1 (that will be described below with reference to FIG. 7) are according to an embodiment mainly located in housing part 2b. The display 3 and keypad area 7a are part of the third housing part 2c. The display 3 and the keypad area 7a are connected to the electronic components inside housing part 2b by a flexible print, conducting tracks in combination with guide shoes, cables or the like (not shown). The keypad area 7b is disposed on the second housing part 2b, and has therefore direct electronic contact with the electronic components inside the second housing part 2b.

FIG. 7 illustrates in block diagram form the general architecture of a mobile phone 1 constructed in accordance with the present invention (this block diagram applies to both the first and the second embodiment described above). The processor 18 controls the operation of the terminal and has an integrated digital signal processor 17 and an integrated RAM 15. The processor 18 controls the communication with the cellular network via the transmitter/receiver circuit 19 and an internal antenna 20. A microphone 6 coupled to the processor 18 via voltage regulators 21 transforms the user's speech into analogue signals, the analogue signals formed thereby are A/D converted in an A/D converter (not shown) before the speech is encoded in the DSP 17 that is included in the processor 18. The encoded speech signal is transferred to the processor 18, which e.g. supports the GSM terminal software. The digital signal-processing unit 17 speech-decodes the signal, which is transferred from the processor 18 to the speaker 5 via a D/A converter (not shown).

The voltage regulators 21 form the interface for the speaker 5, the microphone 6, the LED drivers 19 (for the LEDS backlighting the keypad 7 and the display 3), the SIM card 22, battery 24, the bottom connector 27, the DC jack 31 (for connecting to the charger 33) and the audio amplifier 32 that drives the (hands-free) loudspeaker 25.

The processor 18 also forms the interface for some of the peripheral units of the device, including a Flash ROM memory 16, the graphical display 3, the keypad 7, the navigation up key 11, the navigation down key 12, the horizontal scroll bar 13, an FM radio 26, a third housing part sensor 42 and a second housing part sensor 43.

The third part housing sensor 42 provides a signal corresponding to the actual position of the third housing part 2c relative to the second housing part 2b, so that the processor 18 can determine whether the third housing part 2c is in its extended or in its retracted position. Similarly, the second housing part sensor 43 provides a signal corresponding to the actual position of the second housing part 2b relative to the first housing part 2a, so that the processor 18 can determine whether the second housing part 2b is in its extended or in its retracted position.

According to an embodiment, the software in the respective memory 15,16 instructs the processor 18 to control the state of the mobile phone 1 in accordance with the detected positions of the mobile phone. When the processor 18 receives a signal from the second housing part sensor 43 that the second housing part is in its retracted position (which means that the phone is in the compact position) it will initiate a dormant state for the electronic components of mobile 1. In the dormant state, the mobile phone is not active, and it will not alert/notify the user of any incoming calls or messages. In the dormant state the display 3 and the display backlighting are also switched off. In the dormant state the mobile phone 1 still consumes power and registers events, such as incoming calls or messages. In order to indicate to the user that the mobile phone 1 is still using power, a blinking LED (not shown) can be provided on the housing 2.

When the processor 18 receives a signal from the second housing part sensor 43 that the second housing part is in the extended position (which means that the mobile phone 1 is in the intermediate position) it will initiate an active state for the electronic components of the mobile phone and events, such as incoming calls or incoming messages will be notified to the user via the speaker 55, the display 3 and/or vibration (vibration device not shown).

In order to accept an incoming call, the user can press the softkey 10 (labeled “Answer” when an incoming call is detected) or move the third housing part 2c to its extended position (thereby placing the mobile phone 1 in the elongated position). The processor 18 will via the third housing part sensor 42 notice that the third housing part 2c has been moved to its extended position and thereupon accept the incoming call. When the user subsequently pushes the third housing part 2c back to its retracted position the processor 18 will end the call (alternatively, the user can press the softkey 10 that is labeled “End” during an ongoing call).

The movement of the third housing part 2c between its retracted and extended position can also be used for controlling other functions associated with the mobile phone 1, such as opening received messages and the like.

The various aspects of the invention described above can be used alone or in various combinations. The invention is preferably implemented by a combination of hardware and software, but can also be implemented in hardware or software.

The invention has numerous advantages. Different embodiments or implementations may yield one or more of the following advantages. It should be noted that this is not an exhaustive list and there may be other advantages which are not described herein. One advantage of the invention is that the device has a plurality of easily recognizable states/housing configurations. Another advantage is that a user is able to control a plurality of state of the mobile phone 1 by a mechanical action of moving a housing part. A third advantage is that the housing can assume a compact position in which it has very small dimensions.

The term “comprising” as used in the claims does not exclude other elements or steps. The term “a” or “an” as used in the claims does not exclude a plurality. The single processor or other unit may fulfill the functions of several means recited in the claims.

Although the present invention has been described in detail for purpose of illustration, it is understood that such detail is solely for that purpose, and variations can be made therein by those skilled in the art without departing from the scope of the invention. For example, although the invention has been described in terms of a mobile phone, it should be appreciated that the invention may also be applied to other types of electronic devices, such as cameras, video recorders, music players, palmtop computers and the like.

1. A mobile electronic device comprising:
a housing having at least a first housing part, a second housing part, and a third housing part,
said third housing part being mounted for slidable movement relative to the second housing part between an extended position and a retracted position,
said second housing part being mounted for slidable movement relative to the first housing part between an extended position and a retracted position,
said housing being configured to be able to assume a compact position in which the third housing part is in its retracted position relative to the second housing part and in which the second housing part is in its retracted position relative to the first housing part,
said housing being configured to be able to assume an intermediate position in which the third housing part is in its retracted position relative to the second housing part and in which the second housing part is in its extended position relative to the first housing part, and
said housing being configured to be able to assume an elongated position in which the third housing part is in its extended position relative to the second housing part and in which the second housing part is in its extended position relative to the first housing part.

2. An electronic device according to claim 1, wherein the direction of the slidable movement between the third housing part and the second housing part is substantially identical with the slidable movement between the second housing part and the first housing part.

3. An electronic device according to claim 1 or 2, further comprising an operating face that includes at least two distinct operating face areas, wherein:
said first housing part conceals both of said two distinct operating face areas in said compact position,
said first housing part conceals only one of said two distinct operating face areas in said intermediate position, and
said first housing part does not conceal any one of said two distinct operating face areas in said elongated position.

4. An electronic device according to claim 3, wherein one of said distinct operating face areas is disposed on said third housing part.

5. An electronic device according to claim 3 or 4, wherein one of said distinct operating face areas is disposed on said second housing part.

6. A mobile electronic device according to any of claims 1 to 5, wherein the electronic system of the device assumes a dormant state when said housing is brought in the compact position.

7. A mobile electronic device according to any of claims 1 to 6, wherein said electronic system assumes an active state when said housing is moved out of the compact position.

8. A mobile electronic device according to any of claims 1 to 7, wherein said compact position, said intermediate position and said elongated position are stable positions.

9. A mobile electronic device according to claim 8, wherein a given amount of force has to be applied to said housing parts before they move out of one of said stable positions.

10. A mobile device according to any of claims 1 to 9, wherein said compact position is an automatically locking position that requires pressing one or more release keys to unlock.

11. A mobile device according to any of claims 1 to 10, wherein one or more release keys have to be pressed before the housing can be moved from the intermediate position to the compact position.

12. A mobile device according to any of claims 1 to 11, wherein said intermediate position is in between said retracted position and said extended position.

13. A mobile device according to any of claims 1 to 12, wherein resilient means are provided to bias said first housing part, said second housing part and said third housing part towards their retracted and/or extended positions.

14. A mobile device according to any of claims 1 to 13, wherein a first of said distinct operating face areas includes an alphanumerical keypad.

15. A mobile device according to claim 14, wherein the alphanumeric keypad is a UTI-T keypad.

16. A mobile device according to claim 14 or 15, wherein said first distinct operating face area is disposed on the second housing part.

17. A mobile device according to any of claims 1 to 16 wherein a second of said distinct operating face areas includes navigational user interface components.

18. A mobile device according to claim 17, wherein said second distinct operating face area includes one or more soft keys.

19. A mobile device according to claim 17 or 18, wherein said second distinct operating face is disposed on the third housing part.
